(19) United States
(12) Patent Application Publication
(10) Pub. No.: US 2025/0181057 A1
(43) Pub. Date: Jun. 5, 2025

(54) HMI SCREEN DESIGNING DEVICE AND SCADA WEB HMI SYSTEM

(71) Applicant: TOSHIBA MITSUBISHI-ELECTRIC INDUSTRIAL SYSTEMS CORPORATION, Tokyo (JP)

(72) Inventors: Ryo SHIMIZU, Tokyo (JP); Akira NOJIMA, Tokyo (JP); Nobuo SHIMIZU, Tokyo (JP)

(73) Assignee: TOSHIBA MITSUBISHI-ELECTRIC INDUSTRIAL SYSTEMS CORPORATION, Tokyo (JP)

(21) Appl. No.: 18/845,889

(22) PCT Filed: Feb. 13, 2023
(86) PCT No.: PCT/JP2023/004838

§ 371 Date: Sep. 11, 2024

(51) Int. Cl. G05B 19/4155

(52) U.S. Cl. CPC G05B 19/4155; G05B 2219/32404

(57) ABSTRACT

There is provided an HMI screen creation device that enables creation of an HMI screen in which a plurality of operation elements are exclusively arrangeable with high flexibility, without deteriorating quality of the HMI screen. An HMI screen designing device according to the present disclosure includes: a drafting processing unit including a stencil area where a plurality of operation elements to be arranged in the HMI screen are arranged to be selectable, and a drafting area where a drawing is drawn by arranging the operation elements selected in the stencil area; and a drawing data generation processing unit configured to generate drawing data as data of the drawing in which the plurality of operation elements are arranged. The drafting processing unit includes exclusive grouping means for mutually exclusively grouping the plurality of operation elements arranged on the drawing.

### TECHNICAL FIELD

The present invention relates to an HMI screen designing device that creates an HMI screen dynamically displayed on a web browser of a SCADA web HMI system, and to a SCADA web HMI system including the HMI screen designing device.

### BACKGROUND ART

A SCADA (supervisory control and data acquisition) is known as a mechanism supervising and controlling a social infrastructure system. The social infrastructure system includes a steel rolling system, a power transmission and transformation system, a water and sewage treatment system, a building management system, and a road system. The SCADA is a type of industrial control system that performs system supervision and process control by a computer. The SCADA requires quick responsiveness (real-time property) corresponding to processing performance of the system.

The SCADA includes, as sub-systems, an HMI (human machine interface), a supervisory control system, and a remote input/output Device (remote input output: RIO).

The HMI is a mechanism that displays data, operation buttons, and the like of an object process (supervisory object device) on an HMI screen, and controls the object process through supervision of the process and operation of the operation buttons by an operator. The supervisory control system collects signal data on the process (PLC signals), and transmits control commands to the process. The supervisory control system includes a PLC (programmable logic controller).

In a general-purpose SCADA, an HMI screen designer creates the HMI screen by using a script program (hereinafter, referred to as “script”). After creation of the HMI screen is completed, types, the number, arrangement, and the like of articles corresponding to the operation buttons and the like displayed on the HMI screen are changed in some cases based on a request from the social infrastructure system. In this case, a user such as a process engineer changes the HMI screen by recreating the script; however, compatibility with the other programs operating in the SCADA is low, which causes quality deterioration of the HMI screen.

For example, a SCADA web HMI system disclosed in PTL 1 described below includes a designing device that includes an engineering tool creating a drawing used as an HMI screen. A stencil area and a drafting area are displayed side by side on a drawing creation screen displayed by the engineering tool. A plurality of types of operation elements necessary for creating a drawing are arranged in the stencil area so as to be selectable by the HMI screen designer. The operation elements are also referred to as operation articles or operation parts. In the drafting area, operation elements in the stencil area selected by the HMI screen designer can be arranged at optional positions (drag and drop). According to the technique, it is unnecessary to create the script unlike the general-purpose SCADA. This makes it possible to improve designing efficiency of the HMI screen without deteriorating quality of the HMI screen.

When the plurality of operation elements are displayed on the HMI screen, for example, the plurality of operation elements may cause operations opposite to each other. The operations opposite to each other are operations not compatible with each other, for example, opening operation and closing operation of a valve, driving and stoppage of a motor, and forward rotation and reverse rotation of the motor. In terms of preventing erroneous operation on the supervisory object device, for example, two-action operation by an operator on the HMI screen may be adopted. The two-action operation indicates that an execution button is displayed together with the plurality of operation elements on the HMI screen, and after at least one operation element is selected from the plurality of operation elements, the execution button is pressed. In a case where such two-action operation is adopted, it is necessary to exclusively display the plurality of operation elements on the HMI screen in a state (EXE waiting state) before the execution button is pressed. In other words, when the operator selects one operation element from the plurality of operation elements on the HMI screen, it is necessary to display the other operation element causing operation opposite to the selected operation element so as not to be selectable. When the plurality of operation elements exclusively displayed are previously arranged in the stencil area, the elements are selectable by the HMI screen designer.

### CITATION LIST

### Patent Literature

[PTL 1] WO 2022/003818

### SUMMARY OF THE INVENTION

### Problems to be Solved by the Invention

However, when the number of operation elements exclusively displayed, an interval between adjacent operation elements, and the like are used as parameters, a display form of the plurality of operation elements on the HMI screen is diversified. Therefore, it is difficult to arrange all of display forms of the plurality of operation elements exclusively displayed, in the stencil area. Further, any display form can be realized by recreating the script as with the general-purpose SCADA, but this causes quality deterioration as described above.

The present disclosure has been made to solve the above-described problems. An object of the present disclosure is to provide an HMI screen creation device that enables creation of an HMI screen in which a plurality of operation elements are exclusively arrangeable with high flexibility, without deteriorating quality of the HMI screen, and a SCADA web HMI system including the HMI screen creation device.

### Solution to Problem

The present disclosure relates to an HMI screen designing device creating an HMI screen dynamically displayed on a web browser of a SCADA web HMI system. The HMI screen designing device comprises a drafting processing unit and a drawing data generation processing unit. The drafting processing unit includes a stencil area where a plurality of operation elements to be arranged in the HMI screen are arranged to be selectable, and a drafting area where a drawing is drawn by arranging the operation elements selected in the stencil area. The drawing data generation processing unit is configured to generate drawing data as data of the drawing in which the plurality of operation elements are arranged. The drafting processing unit includes exclusive grouping means for mutually exclusively grouping the plurality of operation elements arranged on the drawing.

A second aspect further includes the following characteristics in addition to the first aspect. The drafting processing unit further includes mutual relationship defining means for defining mutual exclusive relationship or non-exclusive relationship of the plurality of operation elements grouped by the exclusive grouping means.

A third aspect further includes the following characteristics in addition to the second aspect. The mutual relationship defining means defines the exclusive relationship or the non-exclusive relationship on a table.

A fourth aspect further includes the following characteristics in addition to the first or second aspect. An execution button for executing an operation element selected on the HMI screen is further arranged to be selectable in the stencil area, and the drawing is drawn by arranging, in the drafting area, the operation elements and the execution button selected in the stencil area. According to the fourth aspect, the HMI screen, in which the operation element and the execution button are arranged, can be formed. Therefore, it is possible to cope with the case where two-action operation by the operator is adopted on the HMI screen.

A fifth aspect relates to a SCADA web HMI system. The SCADA web HMI system comprises the HMI screen designing device according to any one of first to fourth aspects and a SCADA web HMI execution device configured to display the HMI screen on a web browser by reading the drawing data generated by the drawing data generation processing unit of the HMI screen designing device.

### Advantageous Effects of the Invention

According to the present disclosure, since the drafting processing unit includes the exclusive grouping means, it is possible to create the HMI screen in which the plurality of operation elements are exclusively arrangeable with high flexibility. In addition, since the HMI screen is not created by using the script unlike the general-purpose SCADA, quality of the HMI screen displayed on the web browser is not deteriorated.

### BRIEF DESCRIPTION OF DRAWINGS

FIG. 1 is a diagram illustrating a configuration of a SCADA web HMI system including an HMI screen designing device according to Embodiment.

FIG. 2 is a block diagram illustrating an example of a hardware configuration of a SCADA web HMI execution device and an HMI screen designing device.

FIG. 3 is a block diagram to explain main processing performed in an engineering tool and a web browser of the HMI screen designing device.

FIG. 4 is a diagram illustrating a first example of a drawing creation screen displayed by the engineering tool.

FIG. 5 is a diagram illustrating a second example of the drawing creation screen displayed by the engineering tool.

### DESCRIPTION OF EMBODIMENT

An embodiment of the present invention is described in detail below with reference to drawings. When numerals of the number, the quantity, the amount, the range, and the like of each of the elements are mentioned in the embodiment described below, the present invention is not limited to the mentioned numerals except for a case of being particularly clearly mentioned and a case of being obviously specified to the numerals in principle. Further, a structure and the like described in the embodiment described below are not necessarily essential for the present invention except for the case of being particularly clearly mentioned and the case of being obviously specified to the structure and the like in principle. Elements common to the drawings are denoted by the same reference numerals, and repetitive description is omitted.

### 1-1. Entire System

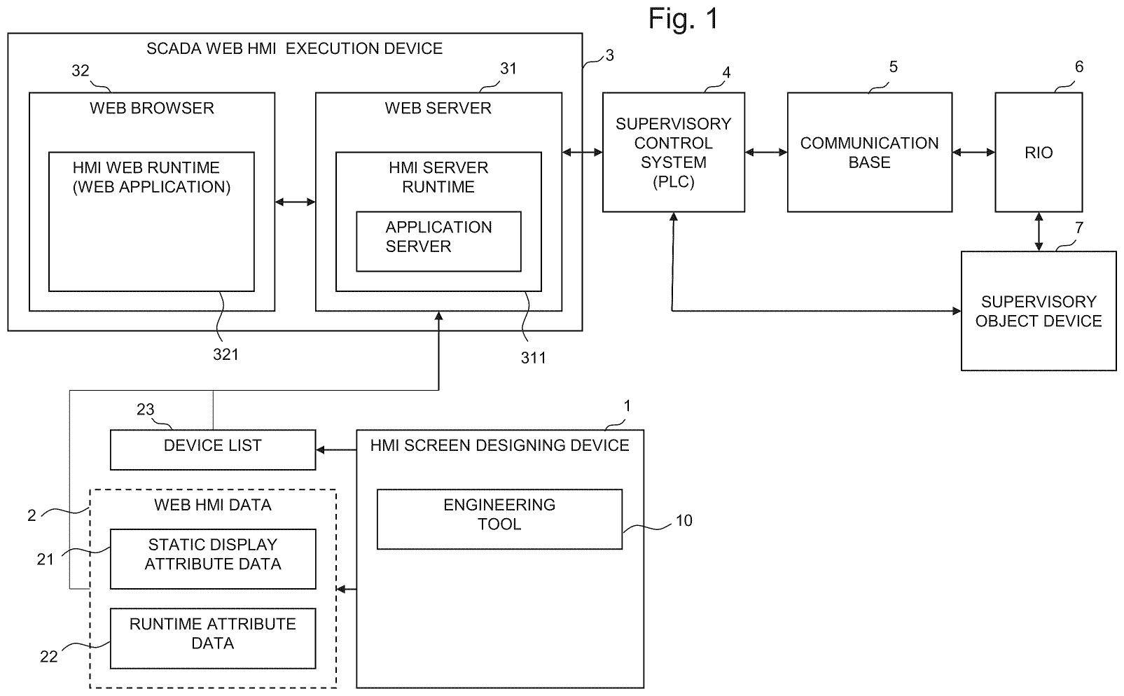

FIG. 1 is a diagram illustrating a configuration of a SCADA web HMI system. The SCADA web HMI system includes an HMI screen designing device 1 as an HMI development environment. The SCADA web HMI system includes, as sub-systems, a SCADA web HMI execution device 3, a supervisory control system 4, a communication base 5, and an RIO 6. The supervisory control system 4, the communication base 5, and the RIO 6 are described in Background Art. Therefore, description thereof is omitted. The supervisory control system 4 includes a programmable logic controller (PLC). A supervisory object device 7 is a sensor, an actuator, or the like constituting a plant to be supervised and controlled.

The HMI screen designing device 1 executes an engineering tool 10. The engineering tool 10 includes an advanced drawing creation/editing function, a function of storing drawing data in a SVG (scalable vector graphics) format, and an extension function. The drawing editing function and the SVG data storing function are realized by Microsoft Visio® as an example. The engineering tool 10 generates web HMI data 2 and a device list 23 that are necessary to operate the SCADA web HMI execution device 3 as an HMI execution environment. The HMI screen designing device 1 is implemented with a GUI as a user interface for executing the engineering tool 10. Details of the HMI screen designing device 1 are described below.

The SCADA web HMI execution device 3 (HMI sub-system) includes a web server 31 and a web browser 32. The SCADA web HMI execution device 3 operates as the HMI sub-system by cooperation of an HMI server runtime 311 operating on the web server 31 and an HMI web runtime 321 operating on the web browser 32.

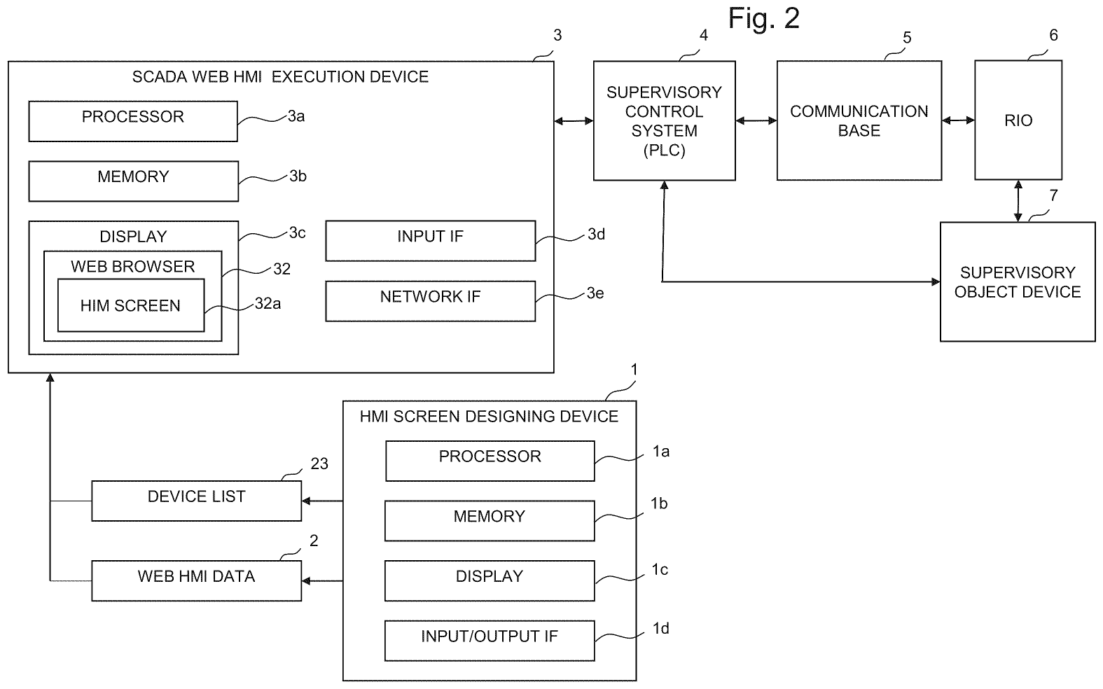

The web browser 32 displays an HMI screen 32a that is a screen for supervising the plant (see FIG. 2). Although not illustrated, a part displaying a state of the plant is arranged, and an operation element for operating the supervisory object device 7 through the supervisory control system 4 is arranged in the HMI screen 32a. The web server 31 communicates with the web browser 32 and the supervisory control system 4. For example, in a case where a PLC signal received from the supervisory control system 4 is a signal about the HMI screen 32a currently displayed on the web browser 32, the web server 31 transmits the PLC signal to the web browser 32. As a result, the SCADA web HMI execution device 3 changes an appearance of the part arranged in the HMI screen 32a based on a value of the PLC signal received from the supervisory control system 4. Details of the SCADA web HMI execution device 3 are described below.

A hardware configuration of main units of the SCADA web HMI system is described with reference to FIG. 2. FIG. 2 is a block diagram illustrating an example of a hardware configuration held by the SCADA web HMI system.

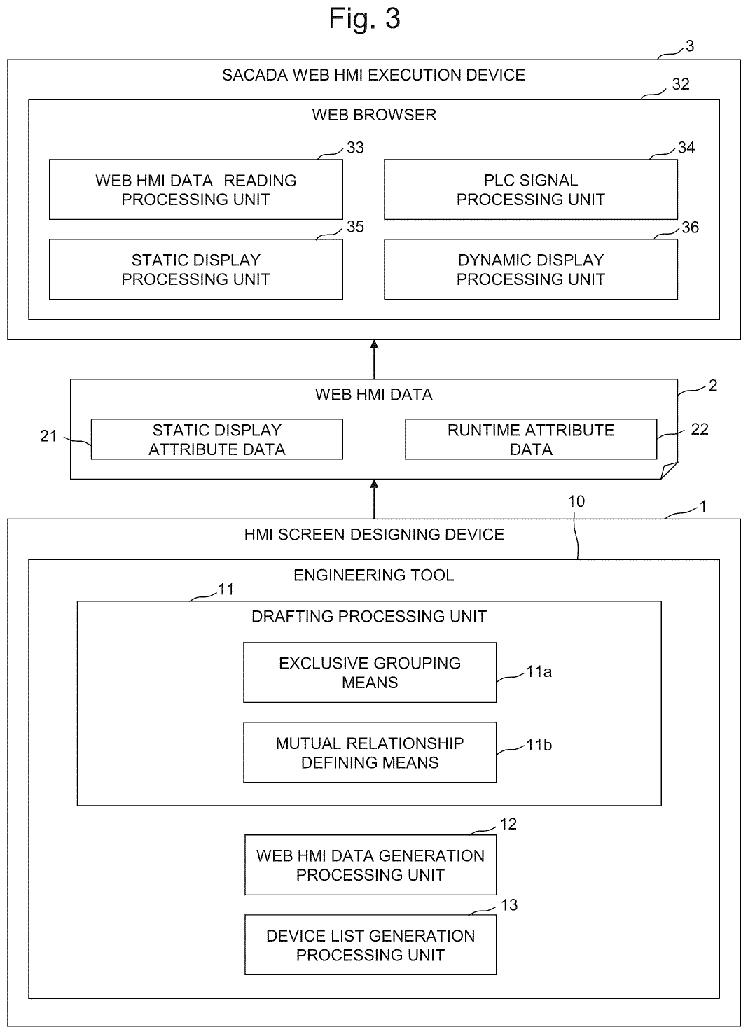

Each processing of the HMI screen designing device 1 illustrated in FIG. 3 is realized by a processing circuit illustrated in FIG. 2. The processing circuit includes a processor 1a, a memory 1b, a display 1c, and an input/output interface 1d that are connected to one another. The input/output interface 1d includes an input device such as a keyboard and a mouse, and an output device that can output a file of the web HMI data 2 and a file of the device list 23. The processor 1a realizes the processing of the HMI screen designing device 1 by executing various kinds of programs stored in the memory 1b.

Each processing of the SCADA web HMI execution device 3 illustrated in FIG. 3 is realized by a processing circuit illustrated in FIG. 2. The processing circuit includes a processor 3a, a memory 3b, a display 3c, an input interface 3d, and a network interface 3e that are connected to one another. The input interface 3d includes an input device such as a keyboard and a mouse, and a device that can read the web HMI data 2 and the device list 23. The display 3c displays the HMI screen 32a created as described below by the screen designing device 1. The HMI screen 32a corresponds to a drawing drawn on a drafting area 111 described below. The network interface 3e is a device that is connected to the supervisory control system 4 and can transmit/receive signal data and a control command. Further, the processor 3a of the processing circuit realizes the processing of the SCADA web HMI execution device 3 by executing various kinds of programs stored in the memory 3b.

### 1-3. Processing by Engineering Tool

FIG. 3 is a block diagram to explain main processing performed by the engineering tool 10 and the web browser 32. The main processing performed by the engineering tool 10 includes drafting processing by a drafting processing unit 11, exclusive grouping processing by an exclusive grouping means 11a, mutual relationship defining processing by a mutual relationship defining means 11b, web HMI data generation processing by a web HMI data generation processing unit 12, and device list generation processing by a device list generation processing unit 13. Contents of the processing by the engineering tool 10 are described below.

### 1-3-1. Drafting Processing

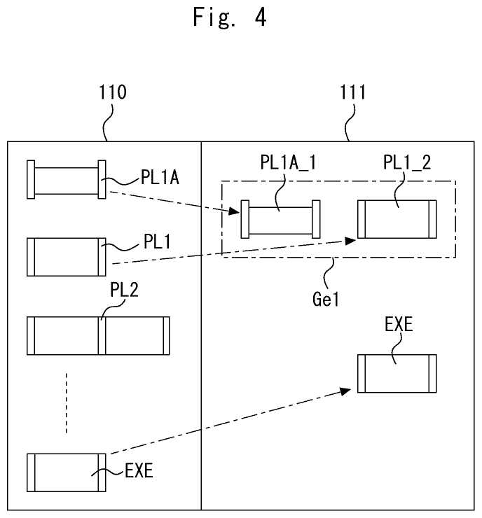

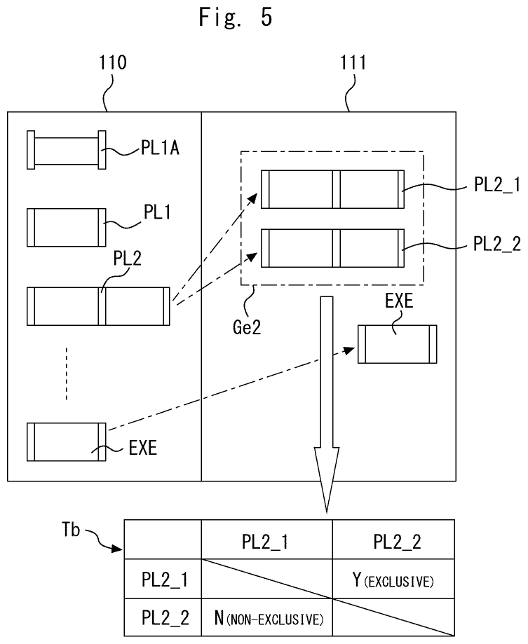

The drafting processing performed by the drafting processing unit 11, more specifically, drafting processing for creating a drawing used as the HMI screen 32a supporting the two-action operation by the operator is described with reference to FIG. 4. FIG. 4 is a diagram illustrating a first example of a drawing creation screen displayed by the engineering tool 10. FIG. 5 is a diagram illustrating a second example of the drawing creation screen displayed by the engineering tool 10. The drawing creation screen is displayed on the display 1c illustrated in FIG. 2.

In the drafting processing, a stencil area 110 in which operation elements for creating a drawing are arranged and the drafting area 111 in which a drawing for the HMI screen is drawn are displayed side by side in the drawing creation screen. The operation elements are master shapes necessary for creating a drawing and are also referred to as operation articles or operation parts. In the drafting processing, the operation elements in the stencil area 110 selected by the HMI screen designer can be arranged on the drawing in the drafting area 111, by using the input/output interface 1d (see FIG. 3).

In the examples illustrated in FIG. 4 and FIG. 5, a plurality of types of operation elements PL1A, PL1, and PL2, . . . are arranged in the stencil area 110 for simplification of illustration. To support the above-described two-action operation, an execution button EXE is arranged together with these operation elements in the stencil area 110. The operation element PL2 includes two operation elements PL1 connected in a right-left direction. These operation elements correspond to operation buttons or operation switches to be operated by the operator in the HMI screen 32a. However, the types of the operation elements are not limited thereto, and a plurality of types of operation elements such as an operation element including connected three operation elements PL1, an operation element including connected four operation elements PL1, and an operation element including connected operation elements PL1A and PL1, may be arranged in the stencil area 110.

The HMI screen designer can copy the operation elements and the execution button EXE in the stencil area 110 in FIG. 4 or FIG. 5, and arrange the operation elements and the execution button EXE at optional positions in the drafting area 111 (drag and drop). When the operation elements and the execution button are arranged in the drafting area 111, a drawing corresponding to the HMI screen 32a is created. Operation elements PL1A_1 and PL1_2 in FIG. 4 and operation elements PL2_1 and PL2_2 in FIG. 5 have been dragged and dropped from the stencil area 110 to the drafting area 111 by the HMI screen designer. Note that “_1” and “_2” are operation element numbers that are identifiers for identifying the operation elements in the drafting area 111. The operation element number is also referred to as an article number. Further, the execution button EXE in FIG. 4 and FIG. 5 has been dragged and dropped from the stencil area 110 to the drafting area 111 by the HMI screen designer, as with the operation elements.

### 1-3-1-1. Exclusive Grouping Processing

The drafting processing unit 11 includes the exclusive grouping means 11a. The exclusive grouping means 11a performs the exclusive grouping processing. In the first example illustrated in FIG. 4, the exclusive grouping means 11a mutually exclusively groups the plurality of (in present embodiment, two) operation elements PL1A_1 and PL1_2 arranged on the drawing in the drafting area 111. In the second example illustrated in FIG. 5, the exclusive grouping means 11a mutually exclusively groups the plurality of operation elements PL2_1 and PL2_2 disposed on the drawing in the drafting area 111. The operation elements to be exclusively grouped can be selected by, for example, designating a range illustrated by an alternate long and short dash line in FIG. 4 and FIG. 5. For example, when characteristics of an exclusive group are imparted to the operation elements PL1A_1 and PL1_2 or the operation elements PL2_1 and PL2_2 on the drawing selected by the HMI screen designer by using the input/output interface 1d (see FIG. 3), exclusive group number Ge1 or Ge2 is imparted. In the first example, when the operator selects any one (for example, PL1A_1) of the operation elements PL1A_1 and PL1_2 displayed on the HMI screen 32a, the other element (for example, PL1_2) can be displayed so as not to be selectable in the selected state (in EXE waiting state). When the operator selects any one of the operation elements PL1A_1 and PL1_2 exclusively grouped on the HMI screen 32a, and then presses the execution button EXE displayed on the HMI screen 32a, operation corresponding to the selected operation element is performed on the supervisory object device 7. In other words, the two-action operation by the operator becomes performable on the HMI screen 32a. Adopting such two-action operation makes it possible to prevent erroneous operation on the supervisory object device 7.

### 1-3-1-2. Mutual Relationship Defining Processing

The drafting processing unit 11 includes the mutual relationship defining means 11b. The mutual relationship defining means 11b performs the mutual relationship defining processing. In the second example illustrated in FIG. 5, mutual exclusive relationship or non-exclusive relationship of the plurality of operation elements PL2_1 and PL2_2 exclusively grouped is defined. The mutual relationship defining means 11b displays a table Tb when the exclusive grouping processing is performed, and exclusive relationship or non-exclusive relationship is defined by input from the HMI screen designer. As illustrated by “Y (exclusive)” in the table Tb, in a case where the operation element PL2_1 is selected on the HMI screen 32a, the operation element PL2_1 is displayed so as not to be selectable. On the other hand, as illustrated by “N (non-exclusive)”, in a case where the operation element PL2_2 is selected on the HMI screen 32a, the operation element PL2_1 is displayed so as to be selectable. As described above, directional relationship of superordinate concept and subordinate concept can be given to the operation elements PL2_1 and PL2_2 exclusively grouped. As a result, designing flexibility of the HMI screen 32a is improved.

### 1-3-2. Web HMI Data Generation Processing

Referring back to FIG. 3, the web HMI data generation processing performed by the web HMI data generation processing unit 12 as a drawing data generation processing unit is described. In the web HMI data generation processing, the web HMI data 2 is generated and output as screen data. The web HMI data 2 includes static display attribute data 21 and runtime attribute data 22. The static display attribute is information in which an appearance of a part is not changed irrespective of the value of the received PLC signal, for example, arrangement information on a part such as a shape, a position, and a size. The runtime attribute is information for changing the appearance of the part based on the value of the received PLC signal. More specifically, the runtime attribute indicates correspondence between the PLC signal and each of color attribute, a type of subset transformation of affine transformation, and a parameter of the transformation.

The static display attribute data 21 is data in which arrangement information and an item name of the operation element (including operation element exclusively grouped) are associated with each other. The static display attribute data 21 is data in a SVG (scalable vector graphics) format, and includes the arrangement information on the operation element as the attribute of an SVG element. More specifically, the arrangement information on the operation element includes a shape, a position, and a size.

The runtime attribute data 22 indicates correspondence between the PLC signal and display information on the operation element, namely, each of the color attribute and the type of subset transformation of the affine transformation. The runtime attribute data 22 includes information indicating that figure transformation is matrix transformation translate (tx, ty) as a subset of the affine transformation. Further, the runtime attribute data 22 includes correspondence information between parameters tx and ty of the matrix transformation and the PLC signal. A dynamic display processing unit 36 operating on the web browser 32 changes the display state of the operation element based on the PLC signal received from the supervisory control system 4 by using a JavaScript® program based on the information.

As such web HMI data 2, data disclosed in PTL 1 described above can be used. Therefore, further detailed description thereof is omitted.

### 1-3-3. Device List Generation Processing

Referring back to FIG. 3, the device list generation processing performed by the device list generation processing unit 13 is described. In the device list generation processing, a device list 23 that is a list of data in which an item name and the PLC signal are associated with each other is generated for each operation element. In the device list 23, the item name and the PLC signal (PLC address for receiving PLC signal) are associated with each other in one-to-one relationship. The device list is read by the web server 31, and is used to transmit/receive signals between the web browser 32 and the supervisory control system 4.

### 1-4. SCADA Web HMI Execution Device (HMI Sub-System)

Referring back to FIG. 1, the SCADA web HMI execution device 3 is described. As described above, the SCADA web HMI execution device 3 includes the web server 31 and the web browser 32.

### 1-4-1. Web Server

The web server 31 reads the web HMI data 2 and the device list 23. The web server 31 reads the web HMI data 2, and arranges the static display attribute data 21 and the runtime attribute data 22 as HMI web runtime contents. The web server 31 reads the device list 23, and enables transmission/reception of the signals between the web browser 32 and the supervisory control system 4.

Processing of the HMI server runtime 311 operating on the web server 31 is as follows. The HMI server runtime 311 includes an application server, and supplies the HMI web runtime contents to the web browser 32. The HMI server runtime 311 communicates with the supervisory control system 4, transmits signal data from the supervisory object device 7 to the HMI web runtime 321, and transmits a control command from the HMI web runtime 321 to the supervisory control system 4.

### 1-4-2. Web Browser

Next, processing of the web browser 32 is described. The web browser 32 can read the web HMI data 2 (static display attribute data 21 and runtime attribute data 22) by a web HMI data reading processing unit 33, and perform static display processing and dynamic display processing. In the static display processing performed by a static display processing unit 35, the web browser 32 reads the static display attribute data 21 as the drawing data in the SVG format from the web server 31, and displays the HMI screen 32a.

In the dynamic display processing performed by the dynamic display processing unit 36, the web browser 32 reads the runtime attribute data 22. The definition of transformation included in the runtime attribute data 22, and the item name and the display information on the operation element are applied as setting parameters to the JavaScript® program. When the information is applied as the setting parameters, the display state of the operation element in the HMI screen 32a is changed based on the PLC signal received by the PLC signal processing unit 34 from the supervisory control system 4.

According to the present embodiment, since the drafting processing unit 11 includes the exclusive grouping means 11a, the plurality of operation elements arranged on the drawing in the drafting area 111 can be mutually exclusively grouped. This makes it possible to create the HMI screen in which the plurality of operation elements are exclusively arrangeable with high flexibility. In addition, since the HMI screen is not created by using the script unlike the general-purpose SCADA, quality of the HMI screen displayed on the web browser 32 is not deteriorated.

Further, since the drafting processing unit 11 further includes the mutual relationship defining means 11b, mutual exclusive relationship or non-exclusive relationship of the plurality of operation elements exclusively grouped can be defined. This makes it possible to give directional relationship of superordinate concept and subordinate concept to the operation elements exclusively grouped. As a result, designing flexibility of the HMI screen 32a is improved.

Further, the execution button EXE is arranged so as to be selectable in the stencil area 10, and the operation elements and the execution button EXE selected in the stencil area 10 are arranged to draw a drawing in the drafting area 111, which makes it possible to create the HMI screen 32a in which the operation elements and the execution button are arranged. This enables the two-action operation by the operator on the HMI screen 32a. Therefore, it is possible to prevent erroneous operation on the supervisory object device 7.

Although the embodiment is described above, the present invention is not limited to the above-described embodiment, and can be variously modified and implemented without departing from the gist of the present invention. In the system according to the above-described embodiment, the drawing data in the SVG format is used; however, the drawing data is not limited thereto. In a case where the web browser 32 supports WebGL, the drawing data may be in a format corresponding to WebGL.

Further, in the above-described embodiment, the SCADA web HMI execution device 3 includes the web server 31 and the web browser 32. Alternatively, a plurality of client terminals may be connected to the web server 31, and the web browser 32 may be displayed on a display of each of the client terminals.

Further, in the above-described embodiment, the case where the two-action operation by the operator is performed on the HMI screen 32a is described as an example; however, the operation is not limited thereto. For example, the execution button may not be arranged on the HMI screen 32a. In this case, when any of the operation elements is selected, operation corresponding to the selected operation element may be performed on the supervisory object device 7. Further, in the above-described embodiment, the execution button EXE is arranged in the stencil area 110 separately from the operation elements; however, the execution button may be arranged as one operation element in the stencil area 110.

### REFERENCE SIGNS LIST

1 . . . . HMI screen designing device, 11 . . . drafting processing unit, 11a . . . exclusive grouping means, 11b . . . mutual relationship defining means, 110 . . . stencil area, 111 . . . drafting area, 12 . . . web HMI data generation processing unit (drawing data generation processing unit), 32 . . . web browser, 32a . . . . HMI screen, PL1, PL1A, PL2 . . . operation element, EXE . . . execution button

1. An HMI screen designing device creating an HMI screen dynamically displayed on a web browser of a SCADA web HMI system, the HMI screen designing device comprising:
drafting processing circuitry including a stencil area where a plurality of operation buttons or operation switches to be arranged in the HMI screen and to be operated by operator are arranged to be selectable, and a drafting area where a drawing is drawn by arranging the operation buttons or the operation switches selected in the stencil area; and
drawing data generation processing circuitry configured to generate drawing data as data of the drawing in which the plurality of operation buttons or operation switches are arranged, wherein
the drafting processing circuitry includes exclusive grouping circuitry for mutually exclusively grouping the plurality of operation buttons or operation switches arranged on the drawing.

2. The HMI screen designing device according to claim 1, wherein the drafting processing circuitry further includes mutual relationship defining circuitry for defining mutual exclusive relationship or non-exclusive relationship of the plurality of operation buttons or operation switches grouped by the exclusive grouping circuitry.

3. The HMI screen designing device according to claim 2, wherein the mutual relationship defining circuitry defines the exclusive relationship or the non-exclusive relationship on a table.

4. The HMI screen designing device according to claim 1, wherein an execution button for executing an operation button or operation switch selected on the HMI screen is further arranged to be selectable in the stencil area, and the drawing is drawn by arranging, in the drafting area, the operation buttons or the operation switches and the execution button selected in the stencil area.

5. A SCADA web HMI system, comprising:
the HMI screen designing device according to claim 1; and
a SCADA web HMI execution device configured to display the HMI screen on a web browser by reading the drawing data generated by the drawing data generation processing circuitry of the HMI screen designing device.

6. An HMI screen designing device creating an HMI screen dynamically displayed on a web browser of a SCADA web HMI system, the HMI screen designing device comprising:
circuitry configured to execute
drawing a drawing in a drafting area by arranging a plurality of operation buttons or operation switches selected in a stencil area where the operation buttons or the operation switches to be arranged in the HMI screen and to be operated by operator are arranged to be selectable; and
generating drawing data as data of the drawing in which the plurality of operation buttons or operation switches are arranged, wherein
the drawing the drawing includes mutually exclusively grouping the plurality of operation buttons or operation switches arranged on the drawing.
